(19) United States
(12) Patent Application Publication
(10) Pub. No.: US 2009/0049992 A1
(43) Pub. Date: Feb. 26, 2009

(54) Barbecue gridiron

(76) Inventor: Cheng-Hsing Chien, Fongshan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/892,321

(22) Filed: Aug. 22, 2007

(51) Int. Cl. A47J 37/07

(52) U.S. Cl. 99/357; 99/450

(57) ABSTRACT

A barbecue gridiron includes a hollow pipe; the hollow pipe winds so as to become a mesh-like barbecue gridiron member including many pipe sections, which are in communication with and substantially parallel to each other; connecting pipes are connected to two ends of the winding hollow pipe respectively, and a pump is connected to the connecting pipes to pump water into the winding hollow pipe, i.e. the mesh-like barbecue gridiron member; when food materials are being roasted on the barbecue gridiron over a fire, water will be circulated in the winding hollow pipe so as to help to prevent temperature of the winding hollow pipe from getting too high; consequently, the food materials are prevented from being scorched to be unpalatable before they become cooked.

### BACKGROUND OF THE INVENTION

1. Field of the Invention

The present invention relates to a barbecue gridiron, more particularly one, which comprises a hollow pipe winding to become a mesh-like barbecue gridiron member including many communicating pipe sections, and in which water is circulated to help prevent temperature of the gridiron from getting too high when food materials are being roasted on the gridiron over a fire; thus, the food materials can't be scorched before they become cooked.

2. Brief Description of the Prior Art

In barbecue, people usually put food materials such as meats on a mesh-like frame (gridiron) positioned over a fire produced by means of burning charcoals; thus, the food materials are roasted with the fire.

While food materials are being roasted on the mesh-like frame, they will be coated with various sauces, and turned over frequently so as to be evenly and properly cooked without being scorched. However, food materials still can be scorched to be unpalatable because such mesh-like frames are usually made of metals, which have relatively good heat conductivity. Therefore, it isn't ideal to use such metallic mesh-like frames in barbecue.

### SUMMARY OF THE INVENTION

It is a main object of the present invention to provide an improvement on a barbecue gridiron to overcome the above problems.

A barbecue gridiron according to an embodiment of the present invention includes a hollow pipe; the hollow pipe winds so as to become a mesh-like barbecue gridiron member including many pipe sections, which are in communication with and substantially parallel to each other. Furthermore, the gridiron includes several strengthening bars intersecting and securely joined to the winding hollow pipe; thus, the winding hollow pipe is prevented from changing shape. Connecting pipes are connected to two ends of the winding hollow pipe respectively, and a pump is connected to the connecting pipes to pump water into the winding hollow pipe, i.e. the mesh-like barbecue gridiron member. When food materials are being roasted on the barbecue gridiron over a fire, water will be circulated in the winding hollow pipe so as to help to prevent temperature of the winding hollow pipe from getting too high. Consequently, the food materials are prevented from being scorched to be unpalatable before they become properly cooked.

### BRIEF DESCRIPTION OF THE DRAWINGS

The present invention will be better understood by referring to the accompanying drawings, wherein:

FIG. 1 is a perspective view of the barbecue gridiron of the present invention,

FIG. 2 is a perspective view of the barbecue gridiron of the present invention in use,

FIG. 3 is a horizontal sectional view of the barbecue gridiron of the present invention in use, and

FIG. 4 is a front view of the barbecue gridiron of the present invention in use.

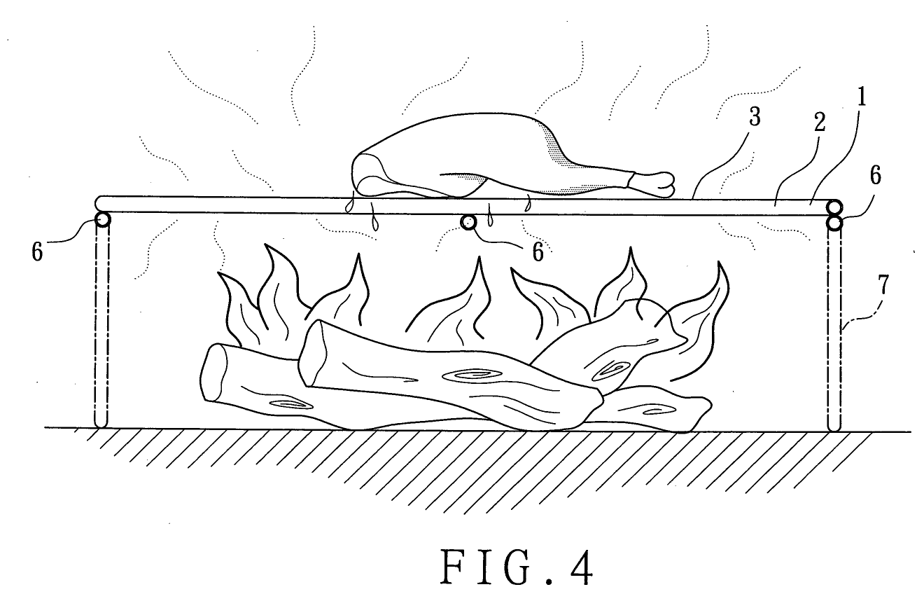

### DETAILED DESCRIPTION OF THE PREFERRED EMBODIMENTS

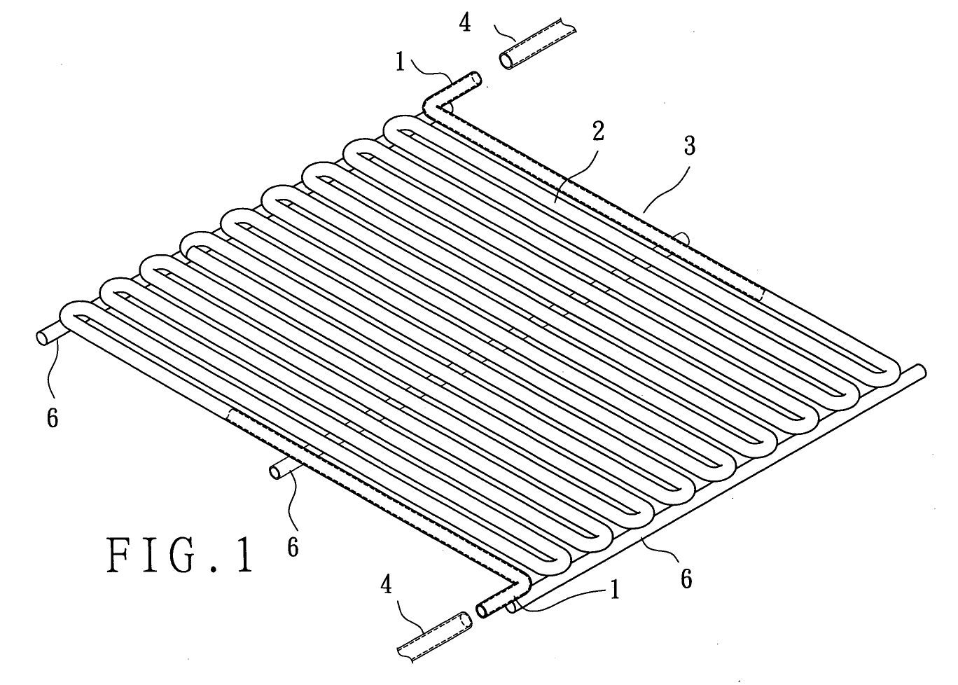

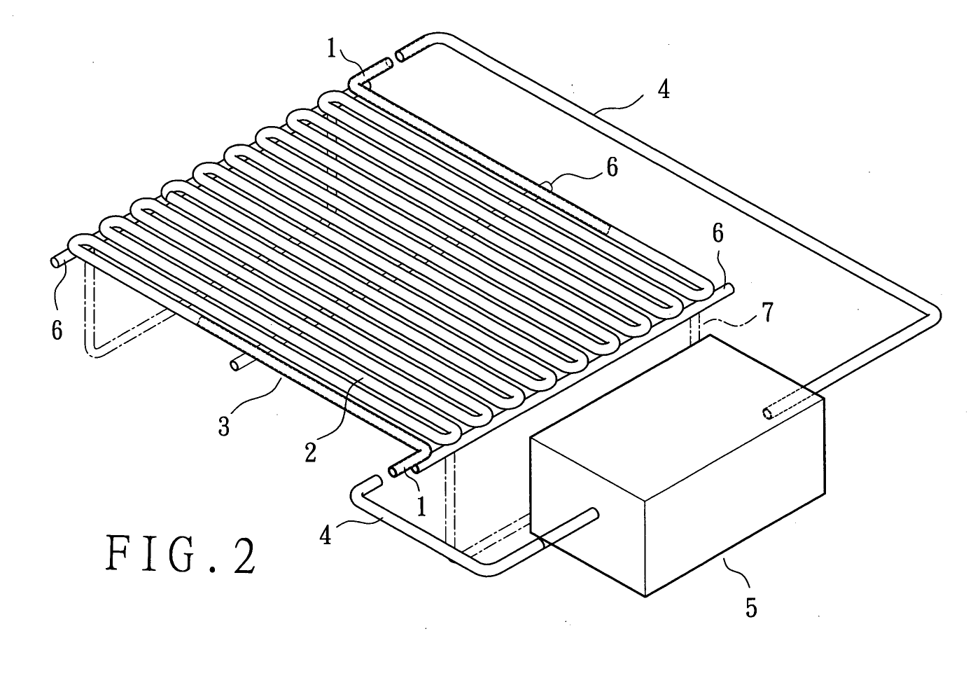

Referring to FIGS. 1 and 2, a preferred embodiment of a barbecue gridiron of the present invention comprises a hollow pipe 1. The hollow pipe 1 winds so as to become a mesh-like barbecue gridiron member 3 including many pipe sections 2, which are in communication with and substantially parallel to each other.

Furthermore, connecting pipes 4 are connected to two ends of the winding hollow pipe part 1 respectively, and a pump 5 is connected to the connecting pipes 4. Therefore, water can be pumped into the winding hollow pipe 1 through the connecting pipes 4 by means of the pump 5; when food materials are being broiled on the mesh-like barbecue gridiron member 3 over a fire, water in the winding hollow pipe 1 will circulate so as to help to reduce temperature, thus preventing temperature of the mesh-like barbecue gridiron member 3 from becoming too high. Consequently, the food materials can be prevented from being scorched before they become properly cooked.

The barbecue gridiron of the present invention further includes several strengthening bars 6, which intersect the mesh-like barbecue gridiron member 3, and are securely joined to the communicating pipe sections 2. Therefore, the pipe sections 2 are firmly connected together so as to prevent the mesh-like barbecue gridiron member 3 from changing shape.

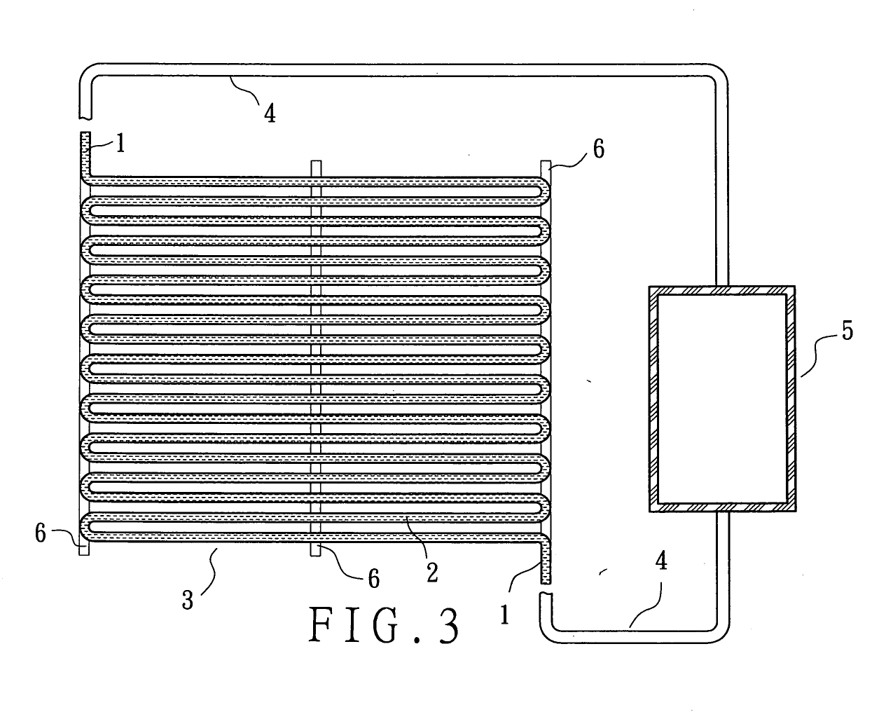

FIG. 3 is a horizontal sectional view of the barbecue gridiron of the present invention, and 4 shows the barbecue gridiron being positioned over a fire for food materials to be roasted on; in use, first the mesh-like barbecue gridiron member 3 is supported above fuels such as charcoal by means of a stand 7, and the pump 5 is connected to the connecting pipes 4 connected to two ends of the winding hollow pipe 1. Next, water is pumped into and circulated in the winding hollow pipe 1 by means of the pump 5. Afterward, food materials are positioned on the mesh-like barbecue gridiron member 3, and the fuels are burned to produce fire to roast the food materials. When the food materials are being roasted on the mesh-like barbecue gridiron member 3 over a fire, water will be circulated in the communicating pipe sections 2 so as to help to prevent temperature of the mesh-like barbecue gridiron member 3 from becoming too high. Consequently, the food materials are prevented from being scorched before they become cooked. And, the food materials will be relatively palatable because they are properly roasted without being scorched.

From the above description, it can be seen that the barbecue gridiron of the present invention has an advantage: the barbecue gridiron comprises the winding hollow pipe to serve as the mesh-like barbecue gridiron member, and water is held in the mesh-like barbecue gridiron member; when food materials are being roasted on the barbecue gridiron over a fire, water will circulate in the mesh-like barbecue gridiron member so as to help to prevent temperature of the mesh-like barbecue gridiron member from becoming too high. Consequently, the food materials are prevented from being scorched to be unpalatable, and they can be properly roasted to be relatively delicious.

What is claimed is:

1. A barbecue gridiron, comprising
a mesh-like barbecue gridiron member comprised of a winding hollow pipe including a plurality of pipe sections, which are in communication with each other; and
a kind of liquid, which is contained in the winding hollow pipe so as to circulate in the communicating pipe sections.

2. The barbecue gridiron as claimed in claim 1, wherein the winding hollow pipe is connected to connecting pipes at two ends thereof; a pump being connected to the winding hollow pipe through the connecting pipes to pump the liquid into the communicating pipe sections.

3. The barbecue gridiron as claimed in claim 1 further comprising a plurality of strengthening bars, which intersect, and are joined to the mesh-like barbecue gridiron member.
